(19) United States
(12) Patent Application Publication
(10) Pub. No.: US 2025/0212246 A1
(43) Pub. Date: Jun. 26, 2025

(54) Power Management for Ambient Power Devices

(71) Applicant: Cisco Technology, Inc., San Jose, CA (US)

(72) Inventors: Robert Barton, VANCOUVER (CA); Juan Carlos Zuniga, MONTREAL (CA); Jerome Henry, Pittsboro, NC (US); Indermeet Gandhi, San Jose, CA (US); Matthew Silverman, Shaker Heights, OH (US); Leo Caldarola, Ecublens (CH)

(21) Appl. No.: 18/597,892

(22) Filed: Mar. 6, 2024

Related U.S. Application Data
(60) Provisional application No. 63/614,359, filed on Dec. 22, 2023.

(51) Int. Cl. H04W 72/56; G08C 17/02; H02J 7/00; H04B 17/318

(52) U.S. Cl. CPC H04W 72/56; G08C 17/02; H04B 17/318; H02J 7/00032

(57) ABSTRACT

Devices, networks, systems, methods, and processes for charging a plurality of ambient power devices are described herein. An ambient power device can include an energy storage. The ambient power device can reserve an amount of charge of the energy storage for generating and transmitting a recharge signal. The ambient power device may generate the recharge signal when a current charge level of the energy storage falls below a threshold charge level indicative of the reserved charge. The recharge signal can be indicative of requiring charging the energy storage immediately. The ambient power device can determine one or more Access Points (APs) that are closest or that have highest signal strengths. The ambient power device may transmit the recharge signal to the one or more APs and receive a charging signal from the one or more APs. The charging signal may be utilized to recharge the energy storage.

### CROSS-REFERENCE TO RELATED APPLICATION

This application claims the benefit of U.S. Provisional Patent Application No. 63/614,359, filed Dec. 22, 2023, which is incorporated by reference herein in its entirety.

The present disclosure relates to wireless communication. More particularly, the present disclosure relates to charging ambient power devices.

### BACKGROUND

Ambient power devices can be of various types. The ambient power devices can be powered by one or more energy sources such as, but not limited to, radio waves, light, motion, heat, or any such ambient energy sources. Some ambient power devices may be passive devices that do not include any energy storage. Such passive devices merely reflect energy, such as Radio Frequency (RF) waves, received in real-time or in near-real time. Some other ambient power devices can be active devices that can include energy storages such as capacitors or batteries to store the energy. Such active devices can delay transmission of data by utilizing the stored energy.

In some conventional techniques of recharging the energy storages of the ambient power devices, an Access Point (AP) may transmit one or more charging frames to the ambient power devices. In some more conventional techniques, the AP can transmit the one or more charging frames when the ambient power devices are scheduled to transmit uplink data. In that, the AP may utilize a predetermined schedule to recharge the ambient power devices. However, in these conventional charging techniques, the AP cannot determine charge levels of the ambient power devices. Further, the energy storages of the ambient power devices are of very limited capacity, and hence, may get discharged quickly.

As a result, the AP also cannot determine when the ambient power devices are about to be fully discharged, or whether the ambient power devices are already discharged. These limitations significantly impact efficiency of charging the ambient power devices. Without accurate information regarding the charge levels and discharge statuses of the ambient power devices, the AP cannot provide timely recharging, thereby leading to interruptions in connectivity of the ambient power devices and failures in operation of the ambient power devices.

### SUMMARY OF THE DISCLOSURE

Systems and methods for charging the ambient power devices and managing power consumption of the ambient power devices in accordance with embodiments of the disclosure are described herein. In some embodiments, a device includes a processor, and a memory communicatively coupled to the processor, wherein the memory includes a power management logic. In some embodiments, a power management logic is configured to monitor a current charge level of an energy storage, compare the current charge level with a threshold charge level, and generate, when the current charge level falls below the threshold charge level, a recharge signal indicative of a request to recharge the energy storage.

In some embodiments, a device, the recharge signal includes one or more encoded identification bits corresponding to a device identifier.

In some embodiments, the power management logic is further configured to determine a required charge level for transmitting an uplink data signal, and determine a priority of transmission of the uplink data signal.

In some embodiments, the recharge signal is further indicative of at least one of the required charge level or the priority of transmission.

In some embodiments, the recharge signal is further indicative of a maximum charge level associated with the energy storage.

In some embodiments, the power management logic is further configured to modulate the recharge signal to generate a modulated recharge signal.

In some embodiments, the power management logic is further configured to detect a plurality of wireless devices, receive one or more Radio Frequency (RF) signals from the plurality of wireless devices, measure one or more signal strengths of the one or more RF signals, and determine one or more wireless devices associated with a highest signal strength of the one or more signal strengths.

In some embodiments, the power management logic is further configured to determine one or more RF channels associated with the one or more wireless devices.

In some embodiments, the power management logic is further configured to transmit at least one of the recharge signal or the modulated recharge signal to the one or more wireless devices on the one or more RF channels.

In some embodiments, the power management logic is further configured to receive at least one charging signal from the one or more wireless devices in response to the recharge signal, and recharge the energy storage based on the at least one charging signal.

In some embodiments, the energy storage is a battery or a capacitor.

In some embodiments, the power management logic is further configured to dynamically modify the threshold charge level.

In some embodiments, a power management logic is configured to receive a first recharge signal, retrieve a first device identifier based on the first recharge signal, identify a first ambient power device associated with the first device identifier, and transmit a first charging signal to the first ambient power device.

In some embodiments, the power management logic is further configured to determine a first required charge level associated with the first recharge signal.

In some embodiments, the power management logic is further configured to determine a first priority of transmission associated with the first recharge signal.

In some embodiments, the power management logic is further configured to generate the first charging signal based on the first required charge level and the first priority of transmission.

In some embodiments, the power management logic is further configured to receive a second recharge signal from a second ambient power device, determine a second priority of transmission associated with the second recharge signal, and compare the first priority of transmission and the second priority of transmission.

In some embodiments, the power management logic is further configured to transmit a second charging signal to the second ambient power device if the second priority of transmission is greater than the first priority of transmission.

In some embodiments, a method includes monitoring a current charge level of an energy storage of an ambient power device, generating one or more encoded identification bits corresponding to a device identifier associated with the ambient power device, comparing the current charge level with a threshold charge level, and generating, when the current charge level falls below the threshold charge level, a recharge signal including the one or more encoded identification bits.

In some embodiments, a method includes generating the recharge signal includes determining a required charge level for transmitting an uplink data signal, determining a priority of transmission of the uplink data signal, and generating the recharge signal based on the required charge level and the priority of transmission, wherein the recharge signal is indicative of a request to recharge the energy storage.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a wireless communication network, in accordance with various embodiments of the disclosure;

FIG. 2 is a conceptual illustration of transmission of frames in a wireless communication network, in accordance with various embodiments of the disclosure;

FIG. 3 is a conceptual network diagram of various environments that a power manager may operate on a plurality of network devices, in accordance with various embodiments of the disclosure;

FIG. 4 is a flowchart depicting a process for generating and transmitting a recharge signal, in accordance with various embodiments of the disclosure;

FIG. 5 is a flowchart depicting a process for selecting an Access Point (AP) or a wireless device, in accordance with various embodiments of the disclosure;

FIG. 6 is a flowchart depicting a process for charging an ambient power device, in accordance with various embodiments of the disclosure;

FIG. 7 is a flowchart depicting a process for prioritizing charging of one or more ambient power devices, in accordance with various embodiments of the disclosure; and

FIG. 8 is a conceptual block diagram of a device suitable for configuration with a power management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that recharge multiple ambient power devices and schedule transmissions from the ambient power devices. A communication network may comprise an Access Point (AP) and one or more ambient power devices. The ambient power devices can be in communication with the AP by way of one or more Radio Frequency (RF) channels. The RF channels may include multiple bands of frequencies. In some embodiments, for example, the bands of frequencies may include Wi-Fi bands such as but not limited to 2.4 GHz, 5 GHZ, or 6 GHz. Some more examples can include millimeter-wave (mmWave) bands. Additional examples can include Sub-1 GHz band frequencies. The ambient power devices can be powered by one or more ambient energy sources such as, but not limited to, radio waves, light, motion, heat, or any such ambient energy sources. Some ambient power devices may be passive devices that do not include any energy storage. Such passive devices merely reflect RF waves, received in real-time or in near-real time. Some other ambient power devices can be active devices that can include energy storages such as but not limited to capacitors or batteries to store the energy. These energy storages can be recharged by utilizing one or more of the ambient energy sources. In many embodiments, in the communication network, the ambient power devices can be in communication with the AP. The ambient power devices may be managed by the AP. In that, the AP can recharge the ambient power devices, i.e., the AP can recharge the energy storages in the ambient power devices. The AP may also schedule uplink transmissions of the ambient power devices.

In a number of embodiments, the ambient power devices, especially the active devices, rely on the energy storages such as but not limited to the capacitors or batteries to function. Some ambient power devices can be sensors, such as but not limited to temperature, pressure, humidity, or health sensors etc. for example. Such sensors can measure one or more physical parameters such as but not limited to temperature, pressure, or humidity values etc. for example. However, energy storage capacities of the batteries or capacitors in the ambient power devices are limited, and hence, may need to be recharged. If the energy storage of an ambient power device is fully discharged, the ambient power device may cease to function. To avoid such an interruption, in some embodiments, the ambient power device can reserve a predetermined amount of charge of the energy storage or a threshold charge level of the energy storage for notifying the AP that the ambient power device needs immediate recharge. In certain embodiments, the threshold charge level may be indicative of the reserved amount of charge.

In various embodiments, the threshold charge level may be configured into the ambient power device by a manufacturer or a vendor. In more embodiments, the AP and/or the ambient power device can dynamically notify and/or modify the threshold charge level associated with the ambient power device. In some more embodiments, the AP and/or the ambient power device can determine the threshold charge level based on one or more parameters, such as but not limited to, a volume of uplink data to be transmitted by the ambient power device, a maximum energy storage capacity associated with the ambient power device, a required charge for uplink transmission, a priority of the uplink transmission, or a volume of data stored in a buffer in the ambient power device etc. for example. The AP and/or the ambient power device can also determine the threshold charge level based on other such parameters. In numerous embodiments, the threshold charge level can be a single voltage value or a range, i.e., a window of voltage values. The threshold charge level may also vary with one or more of: a time of transmission, a mode of operation of the ambient power device, a distance of the ambient power device from the AP, a signal strength of uplink transmission by the ambient power device, modulation or multiplexing techniques utilized for the uplink transmission, or a frequency/time slot assigned to the ambient power device for the uplink transmission. The ambient power device can constantly or periodically monitor a state of charge or a current charge level of the energy storage. The ambient power device may compare a current charge level with the threshold charge level. In some more embodiments, the ambient power device can comprise one or more electronic circuits, such as but not limited to, a voltage comparator, an op-amp, a Schmitt trigger, a window comparator, or a microcontroller-based comparator to compare the current charge level with the threshold charge level.

In additional embodiments, when the current charge level falls below the threshold charge level, the ambient power device can generate a recharge signal. The recharge signal may be transmitted to the AP. The recharge signal can be indicative of a request to recharge the energy storage of the ambient power device. In some embodiments, for example, the ambient power device can be associated with an Internet of Things (IoT) device such as but not limited to smart electronic devices or smart appliances, etc. for example. In certain embodiments, for example, the ambient power device can be associated with a network device such as but not limited to switch, router, gateway, or hub etc. for example. In more embodiments, for example, the recharge signal may be similar to a dying gasp signal transmitted by the IoT device or the network device by utilizing a Last Will and Testament (LWT) message in a Message Queuing Telemetry Transport (MQTT) protocol. The recharge signal can be indicative of an emergency transmission to the AP for alerting the AP to recharge the energy storage of the ambient power device. In some more embodiments, for example, similar to the dying gasp signal, the recharge signal can be indicative of or can be generated based on telemetry data associated with the ambient power device. In more embodiments, for example, the recharge signal may be indicative of one or more reasons for failure of the ambient power device. In some more embodiments, the recharge signal can notify the AP that the ambient power device requires immediate recharge. In numerous embodiments, the recharge signal can be transmitted by way of one or more uplink frames. In some more embodiments, the recharge signal may include a predetermined sequence of bits. The predetermined sequence of bits may be inserted in one or more uplink frames utilized to transmit the recharge signal. The predetermined sequence of bits can be utilized by the AP and/or the wireless device to determine that the uplink frames are indicative of the recharge signal.

In further embodiments, the ambient power device can determine the required charge level for transmitting an uplink signal. The uplink signal may include the uplink frames transmitted by the ambient power device to the AP. The uplink signal can be indicative of uplink data generated by the ambient power device. The uplink data may be indicative of values of the physical parameters measured by the sensors or transducers associated with the ambient power device. In determining the required charge level for transmission of the uplink data, the ambient power device can determine one or more uplink transmission parameters such as but not limited to a number of uplink frames to be transmitted, duration of the uplink frames, or signal strength of the uplink frames etc. The ambient power device may determine the required charge level for transmission of the uplink data based on the uplink transmission parameters. The ambient power device can also determine the priority of the transmission of the uplink data signal. In some embodiments, the priority of the transmission of the uplink data signal may be determined based on urgency or importance of the uplink data, an operational state of the ambient power device, location of the ambient power device, or nature of the uplink data (for e.g. real-time or near-real time), time sensitivity of the uplink data, or volume of the uplink data etc. for example. The priority of the transmission of the uplink data signal can also be determined based on one or more device characteristics or transmission characteristics of the ambient power device. In more embodiments, the priority of the transmission of the uplink data signal may be indicated by a priority field in the uplink frames utilized for transmitting the recharge signal. The priority field can be one or more bits in the uplink frames. Values of the priority field can vary based on the type of the uplink data scheduled to be transmitted by the ambient power device.

In many more embodiments, the recharge signal can be indicative of the required charge level for transmission of the uplink data signal and/or the priority of transmission of the transmission of the uplink data signal. The recharge signal can also be indicative of the maximum energy storage capacity associated with the energy storage in the ambient power device. In some embodiments, the recharge signal may be indicative of a device identifier of the ambient power device. Examples of the device identifiers include but are not limited to, an address (for e.g. Media Access Control (MAC) address) of the ambient power device, device type or name of the ambient power device, or serial number associated with the ambient power device etc. In certain embodiments, the ambient power may encode the device identifier. The recharge signal may be indicative of the encoded device identifier. The ambient power device can also generate one or more encoded identification bits indicative of the encoded device identifier. The ambient power device may insert the encoded identification bits in the one or more uplink frames utilized to transmit the recharge signal. In more embodiments, the ambient power device can encode the recharge signal. The ambient power device may transmit the encoded recharge signal to the AP. In numerous embodiments, the ambient power device can utilize one or more encoding techniques such as but not limited to digital encoding, line coding, or scrambling etc. to encode the recharge signal and/or the device identifier. In many more embodiments, the ambient power device may utilize one or more modulation techniques such as but not limited to amplitude modulation, frequency modulation, or phase modulation etc., for example, to modulate the recharge signal. In numerous embodiments, the ambient power device can utilize simple or reduced modulation techniques to modulate the recharge signal. Utilizing the reduced modulation techniques can facilitate in optimization of the current charge level of the energy storage of the ambient power device. In many embodiments, the ambient power device may modulate the recharge signal by Binary Phase-shift keying (BPSK), for example. In still many embodiments, the choice of the encoding or modulation technique may depend on one or more factors such as but not limited to data rate, noise immunity, bandwidth efficiency, or compatibility with transmission protocols etc.

In many additional embodiments, the ambient power device can share the device identifier and device profile data with the AP at the time of association with the AP or periodically thereafter. In some embodiments, the AP can utilize the device identifiers to identify, authenticate, and/or authorize the ambient power device. The AP may also retrieve the device identifiers or the device profile data by employing a combination of one or more of: network scanning, protocol analysis, physical inspection, and database lookup techniques etc. for example. The ambient power device may transmit the recharge signal multiple times. The ambient power device can also transmit the recharge signal to multiple APs. In more embodiments, the ambient power device may broadcast or transmit the recharge signal to all the APs or wireless devices in communication with the ambient power device.

In many further embodiments, the ambient power device can detect the APs and/or the wireless devices. The ambient power devices may utilize Wi-Fi scanning, signal strength measurement, Service Set Identifier (SSID) broadcasts, Probe Requests/Responses, beacon frames, location-based services, or network discovery protocols etc. for example, to detect the wireless devices or the APs. The wireless devices may function as a receiver, an energizer, a proxy, or a buddy device for the ambient power device. The ambient power device may receive one or more RF signals from the APs and/or the wireless devices. In some embodiments, the RF signals can include beacon frames transmitted by the APs or the wireless devices, for example. In more embodiments, the RF signals may include probe responses transmitted by the APs or the wireless devices in response to probe requests received from the ambient power devices or any other devices. In more embodiments, the RF signals can be Wi-Fi signals. The ambient power device can measure the signal strengths of the RF signals received from the APs and the wireless devices. In that, the ambient power device may measure Received Signal Strength Indication (RSSI) values of the RF signals. In some more embodiments, the RSSI of the RF signals can vary based on one or more parameters such as but not limited to distance of the ambient power device from the APs or the wireless devices, interference, obstacles in vicinity of the ambient power devices, density of devices in an area etc. for example. The ambient power device can determine one or more APs and/or wireless devices having highest signal strengths. In some embodiments, the APs and/or wireless devices having highest signal strengths can be the APs and/or wireless devices closest to the ambient power device. In numerous embodiments, the ambient power devices can store a list of the APs or the wireless devices and corresponding RSSI values. The ambient power device can determine the RF channels associated with the APs and/or wireless devices. The ambient power device can dynamically select an RF channel utilized by the AP or the wireless device. In some embodiments, selecting the RF channels utilized by the closest APs or wireless devices can increase the likelihood that the recharge signal will be heard by the APs or the wireless devices in vicinity. Thereafter, the ambient power device may transmit the recharge signal or the modulated recharge signal to the APs and/or the wireless devices on the selected RF channels.

In still many embodiments, the AP and/or the wireless device can receive the uplink frames. The AP and/or the wireless device may detect the predetermined sequence of bits in the uplink frames. Upon detecting the predetermined sequence of bits, the AP and/or the wireless device can determine that the uplink frames are indicative of the recharge signal. The AP and/or wireless device may also retrieve the device identifier the encoded device identifier, or the encoded identification bits from the uplink frames. The AP and/or wireless device can identify the ambient power device based on the device identifier. The AP and/or wireless device may determine one or more of: the maximum energy storage capacity, the threshold charge level, the current charge level, or the required charge level based on the recharge signal. Thereafter, the AP and/or wireless device can retrieve the priority field from the uplink frames. Upon receiving more than one recharge signals from more than one ambient power devices, the AP and/or wireless device can utilize the priority fields to prioritize charging the ambient power devices. In that, the AP and/or wireless device may first determine the ambient power device associated with higher priority. Thereafter, the AP and/or wireless device can transmit one or more charging frames to the ambient power device associated with the higher priority. In some embodiments, the AP and/or wireless device may determine a number of charging frames based on one or more of: the maximum energy storage capacity, the required charge level, or the threshold charge level etc. The AP and/or the wireless device may determine the number of charging frames and/or a duration of charging frames required to charge the energy storage of the ambient power device to the required charge level and/or the maximum charge level. The ambient power device can utilize the charging frames to recharge the energy storage such as the capacitor or the battery in the ambient power device.

Advantageously, the immediate response of the AP and/or the wireless device to the recharge signals received from the ambient power devices can ensure timely recharge of the ambient power devices, thereby enhancing the reliability and resilience of the communication network. Timely recharge of the ambient power devices may also ensure uninterrupted communication and prevent downtime. The recharging technique of the present disclosure can also ensure that the ambient power devices possess the required charge level for generating the uplink data and/or performing the uplink transmission at any time.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

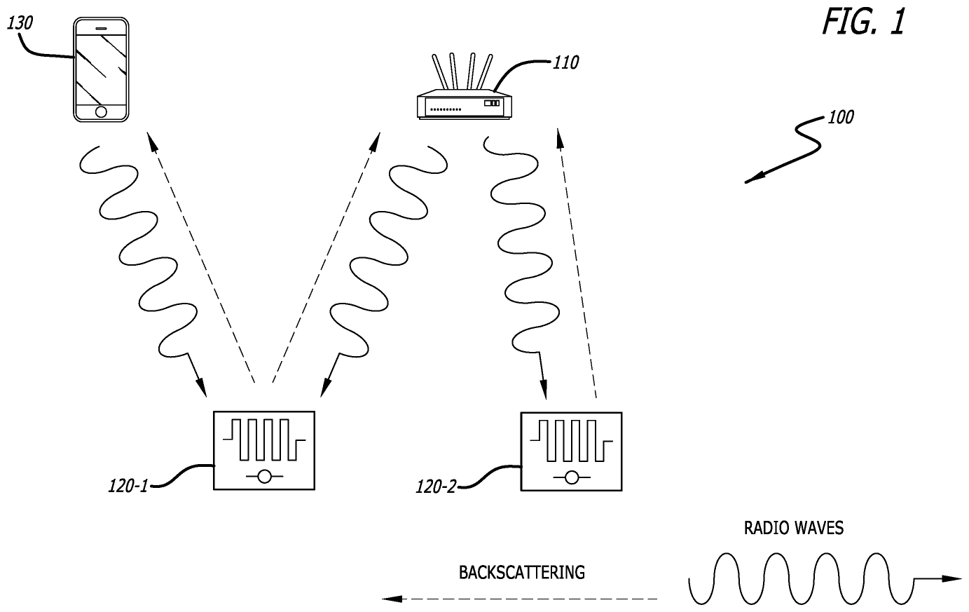

Referring to FIG. 1, a conceptual illustration of a wireless communication network 100, in accordance with various embodiments of the disclosure is shown. In many embodiments, the wireless communication network 100 can include an Access Point (AP) 110, a first ambient power device 120-1 and a second ambient power device 120-2, also collectively referred to as ambient power devices 120, and a wireless device 130. The ambient power devices 120 may be powered by one or more energy sources such as, but not limited to, radio waves, light, motion, heat, or any such ambient energy sources. The ambient power devices 120 may be active devices, i.e., with an energy storage such as a battery or a capacitor etc. or the ambient power devices 120 can be passive devices. The ambient power devices 120 can receive one or more Radio Frequency (RF) signals. The ambient power devices 120 may backscatter the RF signals. In some embodiments, the ambient power devices 120 can modulate and backscatter incident RF signals. In certain embodiments, the ambient power devices 120 can be in communication with the AP 110 by utilizing Wi-Fi bands such as but not limited to 2.4 GHZ, 5 GHZ, or 6 GHz. Some more examples can include millimeter-wave (mm Wave) bands. Additional examples can include Sub-1 GHz band frequencies. Examples of the backscatter communication between the ambient power devices 120, the AP 110, and the wireless device 130 include but are not limited to monostatic backscatter, bistatic backscatter, and ambient backscatter. The wireless device 130 may function as a receiver for backscatter transmission from the ambient power devices 120. Examples of the wireless device 130 include but are not limited to smartphone, tablet, computer, an RF Identification (RFID) tag reader, etc. In certain embodiments, for example, the ambient power devices 120 may be associated with consumer electronic devices or Internet of Things (IoT) enabled devices.

In a number of embodiments, the first ambient power device 120-1 can include a first energy storage such as but not limited to a first battery or a first capacitor. The first ambient power device 120-1 may monitor a current charge level of the first energy storage. The first ambient power device 120-1 can compare the current charge level of the first energy storage with a first threshold charge level. When the current charge level of the first energy storage falls below the first threshold charge level, the first ambient power device 120-1 can generate a first recharge signal indicative of a request to recharge the first energy storage. The first ambient power device 120-1 may transmit the first recharge signal to the AP 110. The first recharge signal may be indicative of one or more of: a first device identifier associated with the first ambient power device 120-1, a first priority of transmission associated with the first ambient power device 120-1, or a first required charge level associated with the first ambient power device 120-1 etc.

Similarly, in various embodiments, the second ambient power device 120-2 can include a second energy storage such as but not limited to a second battery or a second capacitor. The second ambient power device 120-2 may monitor a current charge level of the second energy storage. The second ambient power device 120-2 can compare the current charge level of the second energy storage with a second threshold charge level. When the current charge level of the second energy storage falls below the second threshold charge level, the second ambient power device 120-2 can generate a second recharge signal indicative of a request to recharge the second energy storage. The second ambient power device 120-2 may transmit the second recharge signal to the AP 110. The second recharge signal may be indicative of one or more of: a second device identifier associated with the second ambient power device 120-2, a second priority of transmission associated with the second ambient power device 120-2, or a second required charge level associated with the second ambient power device 120-2 etc.

In additional embodiments, the AP 110 can receive the first recharge signal and the second recharge signal. The AP 110 may retrieve the first and second device identifiers from the first and second recharge signals respectively and may further identify the first ambient power device 120-1 and the second ambient power device 120-2 based on the first and second device identifiers respectively. The AP 110 can further retrieve the first and second priorities from the first and second recharge signals respectively. The AP 110 may determine which of the first and second priorities is higher and may accordingly recharge an ambient power device associated with the higher priority. In some embodiments, for example, if the AP 110 determines that the first priority level is greater than the second priority level, the AP 110 can first recharge the first ambient power device 120-1. To recharge the first energy storage coupled to the first ambient power device 120-1, the AP 110 can transmit one or more charging frames to the first ambient power device 120-1. The first ambient power device 120-1 may recharge the first energy storage based on the charging frames. Thereafter, the AP 110 may recharge the second ambient power device 120-2.

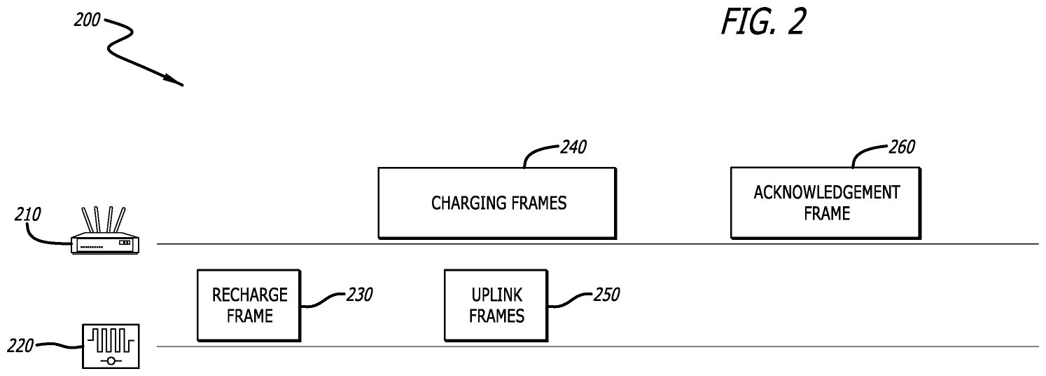

Although a specific embodiment for the wireless communication network 100 for carrying out the various steps, processes, methods, and operations described herein is discussed with respect to FIG. 1, any of a variety of systems and/or processes may be utilized in accordance with embodiments of the disclosure. For example, the AP 110 may dynamically or periodically recharge the ambient power devices 120. The elements depicted in FIG. 1 may also be interchangeable with other elements of FIGS. 2-8 as required to realize a particularly desired embodiment.

Referring to FIG. 2, a conceptual illustration of transmission of frames in a wireless communication network 200, in accordance with various embodiments of the disclosure is shown. In many embodiments, the wireless communication network 200 can include an AP 210 and an ambient power device 220. The ambient power device 220 can detect the AP 210 and determine one or more Radio Frequency (RF) channels associated with the AP 210. Thereafter, the ambient power device 220 may select a first RF channel and transmit a recharge frame 230 indicative of a recharge signal on the first RF channel. The AP 210 can receive the recharge frame 230 and transmit one or more charging frames 240 on a second RF channel. The first and second RF channels may be separated by a frequency offset to facilitate off-channel charging of the ambient power device 220. The ambient power device 220 can receive the one or more charging frames 240 and can recharge the energy storage such as but not limited to the battery or the capacitor etc. for example. In some embodiments, the ambient power device 220 may transmit one or more uplink frames 250 on the first RF channel. The AP 210 can receive the one or more uplink frames 250 and may further transmit an acknowledgement frame 260 to the ambient power device 220 on the second RF channel. The acknowledgement frame 260 can be indicative of the AP 210 successfully receiving the one or more uplink frames 250.

Although a specific embodiment for the wireless communication network 200 for carrying out the various steps, processes, methods, and operations described herein is discussed with respect to FIG. 2, any of a variety of systems and/or processes may be utilized in accordance with embodiments of the disclosure. For example, the one or more uplink frames 250 and the one or more charging frames 240 may be transmitted simultaneously to maintain uninterrupted connectivity between the AP 210 and the ambient power device 220. The elements depicted in FIG. 2 may also be interchangeable with other elements of FIG. 1 and FIGS. 3-8 as required to realize a particularly desired embodiment.

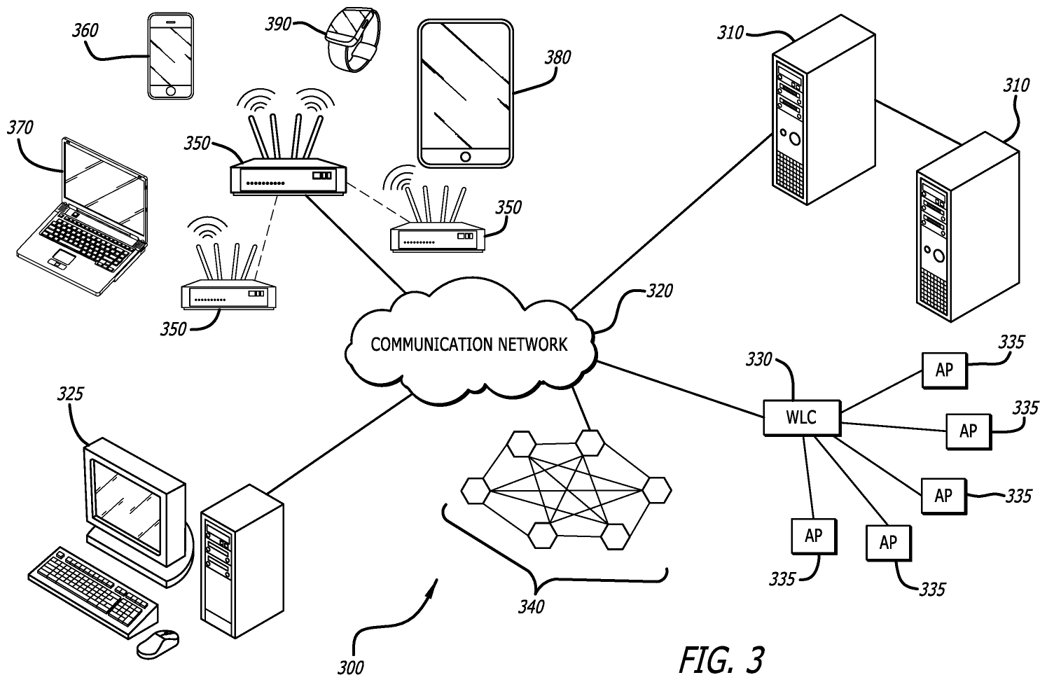

Referring to FIG. 3, a conceptual network diagram 300 of various environments that a power manager may operate on a plurality of network devices, in accordance with various embodiments of the disclosure is shown. Those skilled in the art will recognize that the power manager can be comprised of various hardware and/or software deployments and can be configured in a variety of ways. In many embodiments, the power manager can be configured as a standalone device, exist as a logic in another network device, be distributed among various network devices operating in tandem, or remotely operated as part of a cloud-based network management tool. In further embodiments, one or more servers 310 can be configured with or otherwise operate the power manager. In many embodiments, the power manager may operate on one or more servers 310 connected to a communication network 320. The communication network 320 can include wired networks or wireless networks. In many embodiments, the communication network 320 may be a Wi-Fi network operating on various frequency bands, such as, 2.4 GHZ, 5 GHz, or 6 GHz. In further embodiments, the power manager operating on the servers 310 can facilitate in recharging the ambient power devices and scheduling transmissions from the ambient power devices. The power manager can be provided as a cloud-based service that can service remote networks, such as, but not limited to a deployed network 340. In many embodiments, the power manager can be a logic that recharges the energy storages of the ambient power devices.

However, in additional embodiments, the power manager may be operated as a distributed logic across multiple network devices. In the embodiment depicted in FIG. 3, a plurality of APs 350 can operate as the power manager in a distributed manner or may have one specific device operate as the power manager for all of the neighboring or sibling APs 350. The APs 350 facilitate Wi-Fi connections for various electronic devices, such as but not limited to mobile computing devices including laptop computers 370, cellular phones 360, portable tablet computers 380 and wearable computing devices 390.

In further embodiments, the power manager may be integrated within another network device. In the embodiment depicted in FIG. 3, a wireless LAN controller (WLC) 330 may have an integrated power manager that the WLC 330 can use to recharge the ambient power devices associated with the various APs 335 that the WLC 330 is connected to, cither wired or wirelessly. In still more embodiments, a personal computer 325 may be utilized to access and/or manage various aspects of the power manager, either remotely or within the network itself. In the embodiment depicted in FIG. 3, the personal computer 325 communicates over the communication network 320 and can access the power manager of the servers 310, or the network APs 350, or the WLC 330.

Although a specific embodiment for various environments that the power manager may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the power manager may be provided as a device or software separate from the network devices or the power manager may be integrated into the network devices. The elements depicted in FIG. 3 may also be interchangeable with other elements of FIGS. 1-2 and 4-8 as required to realize a particularly desired embodiment.

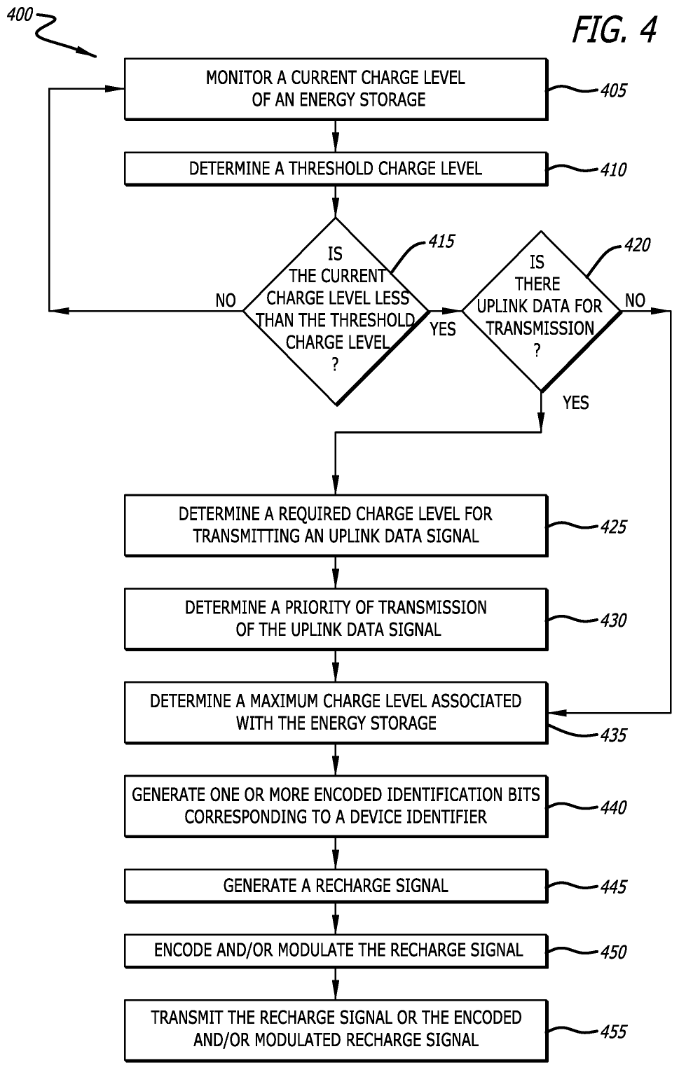

Referring now to FIG. 4, a flowchart depicting a process 400 for generating and transmitting a recharge signal associated with an ambient power device, in accordance with various embodiments of the disclosure is shown. In many embodiments, the process 400 can monitor a current charge level of an energy storage (block 405). In some embodiments, the process 400 may be implemented by an ambient power device. In certain embodiments, the ambient power device can be an active device including the energy storage such as but not limited to a capacitor or a battery etc., for example. In more embodiments, the process 400 can continuously or periodically monitor the current charge level of the energy storage. In some more embodiments, the energy storage coupled to the ambient power device can notify a processing unit within the ambient power device about the current charge level continuously or periodically.

In a number of embodiments, the process 400 may determine a threshold charge level (block 410). In some embodiments, the threshold charge level may be configured into the ambient power device by a manufacturer or vendor. In certain embodiments, the AP and/or the process 400 can dynamically notify and/or modify the threshold charge level associated with the ambient power device. In more embodiments, the AP and/or the process 400 can determine the threshold charge level based on one or more parameters, such as but not limited to, a volume of uplink data to be transmitted by the ambient power device, a maximum energy storage capacity associated with the ambient power device, a required charge for uplink transmission, a priority of the uplink transmission, or a volume of data stored in a buffer in the ambient power device etc. for example. In some more embodiments, the AP and/or the process 400 can also reserve the threshold charge level based on other such parameters. In numerous embodiments, the threshold charge level can be a single voltage value or a range, i.e., a window of voltage values. In many further embodiments, the threshold charge level may also vary with one or more of: a time of transmission, a mode of operation of the ambient power device, a distance of the ambient power device from the AP, a signal strength of uplink transmission by the ambient power device, modulation or multiplexing techniques utilized for the uplink transmission, or a frequency/time slot assigned to the ambient power device for the uplink transmission.

In various embodiments, the process 400 can check if the current charge level is less than the threshold charge level (block 415). In some embodiments, the process 400 may compare a current charge level with the threshold charge level. In certain embodiments, the ambient power device can comprise one or more electronic circuits, such as but not limited to, a voltage comparator, an op-amp, a Schmitt trigger, a window comparator, or a microcontroller-based comparator to compare the current charge level with the threshold charge level. In more embodiments, the process 400 may utilize the one or more electronic circuits in the ambient power device to determine when the current charge level falls below the threshold charge level.

In additional embodiments, if at block 415 the process 400 determines that the current charge level is not less than the threshold charge level, the process 400 can continue monitoring the current charge level (block 405). In some embodiments, the process 400 may perform the uplink transmissions, measure the physical parameters by way of one or more sensors, or generate and process the uplink data normally when the current charge level is above the threshold charge level. In certain embodiments, the process 400 can perform in an operational mode when the current charge level is not less than the threshold charge level, and the process 400 can perform in a low power mode such as a sleep mode or a semi-sleep mode when the current charge level is less than the threshold charge level.

In further embodiments, if at block 415 the process 400 determines that the current charge level is less than the threshold charge level, the process 400 can detect whether there exists any uplink data for transmission (block 420). In some embodiments, the uplink data may be indicative of the values of the physical parameters measured by the sensors of the ambient power device. In certain embodiments, the process 400 can process and/or store the uplink data in a buffer. In more embodiments, the uplink data stored in the buffer can be scheduled for transmission by the process 400.

In many more embodiments, if at block 420 the process 400 determines that there exists uplink data scheduled for transmission, the process 400 can determine a required charge level for generating and transmitting an uplink signal indicative of the uplink data (block 425). In some embodiments, the required charge level may be indicative of an amount of power or energy consumed in generating and/or transmitting one or more uplink frames indicative of the uplink signal. In certain embodiments, in determining the required charge level for transmission of the uplink data, the process 400 can determine one or more uplink transmission parameters such as but not limited to a number of uplink frames to be transmitted, duration of the uplink frames, or signal strength of the uplink frames etc.

In many additional embodiments, the process 400 can determine a priority of transmission of the uplink data signal (block 430). In some embodiments, the process 400 may determine the priority of the transmission of the uplink data signal based on urgency or importance of the uplink data, an operational state of the ambient power device, location of the ambient power device, or nature of the uplink data (for e.g. real-time or near-real time), time sensitivity of the uplink data, or volume of the uplink data etc. for example. In certain embodiments, the process 400 can determine the priority of the transmission of the uplink data signal based on one or more device characteristics or transmission characteristics of the ambient power device.

In many further embodiments, after block 430 and/or if at block 420 the process 400 determines that there is no uplink data scheduled for transmission, the process 400 may determine a maximum charge level associated with the energy storage (block 435). In some embodiments, the maximum charge level may be associated with the capacitor or the battery of the ambient power device. In certain embodiments, the process 400 can notify the AP about the maximum charge level at the time of association of the ambient power device with the AP or periodically thereafter.

In still many embodiments, the process 400 may generate one or more encoded identification bits corresponding to a device identifier (block 440). In some embodiments, examples of the device identifiers include but are not limited to, an address (for e.g. Media Access Control (MAC) address) of the ambient power device, device type or name of the ambient power device, or serial number associated with the ambient power device etc. In certain embodiments, the process 400 can utilize one or more encoding techniques such as but not limited to digital encoding, line coding, or scrambling etc. to encode the device identifier.

In still further embodiments, the process 400 can generate the recharge signal (block 445). In some embodiments, the recharge signal can be indicative of requesting to recharge the energy storage of the ambient power device, or can alert the AP to recharge the energy storage of the ambient power device urgently. In certain embodiments, the recharge signal can be indicative of or can be generated based on telemetry data associated with the ambient power device. In more embodiments, the recharge signal may be indicative of one or more reasons for failure of the ambient power device. In numerous embodiments, the recharge signal can be transmitted by way of the uplink frames. In some embodiments, the recharge signal may include a predetermined sequence of bits. In certain embodiments, the predetermined sequence of bits may be inserted in the uplink frames such that the AP can determine that the uplink frames are indicative of the recharge signal upon detecting the predetermined sequence of bits in the uplink frames. In more embodiments, the process 400 may insert the encoded identification bits in the one or more uplink frames utilized to transmit the recharge signal. In some more embodiments, the priority of the transmission of the uplink data signal may be indicated by a priority field in the uplink frames utilized for transmitting the recharge signal.

In numerous embodiments, the process 400 may encode and/or modulate the recharge signal (block 450). In some embodiments, the process 400 can utilize simple or reduced modulation techniques to modulate the recharge signal. In certain embodiments, utilizing the reduced modulation techniques can facilitate in optimization of the current charge level of the energy storage of the ambient power device. In more embodiments, the process 400 may modulate the recharge signal by Binary Phase-shift keying (BPSK), for example. In some more embodiments, the choice of the encoding or modulation technique may depend on one or more factors such as but not limited to data rate, noise immunity, bandwidth efficiency, or compatibility with transmission protocols etc.

In many embodiments, the process 400 can transmit the recharge signal or the encoded and/or modulated recharge signal to the AP (block 455). In some embodiments, the process 400 can dynamically select the RF channel utilized by the AP. In certain embodiments, selecting the RF channels utilized by the closest APs can increase the likelihood that the recharge signal will be heard by the APs in the vicinity. In more embodiments, the process 400 may transmit the recharge signal multiple times. In some more embodiments, the process 400 can also transmit the recharge signal to multiple APs. In numerous embodiments, the process 400 may broadcast or transmit the recharge signal to all the APs or wireless devices in communication with the ambient power device.

Although a specific embodiment for the process 400 for generating and transmitting the recharge signal associated with the ambient power device for carrying out the various steps, processes, methods, and operations described herein is discussed with respect to FIG. 4, any of a variety of systems and/or processes may be utilized in accordance with embodiments of the disclosure. For example, the process 400 can ensure that the recharge signal is generated and transmitted before the energy storage is depleted. The elements depicted in FIG. 4 may also be interchangeable with other elements of FIGS. 1-3 and FIGS. 5-8 as required to realize a particularly desired embodiment.

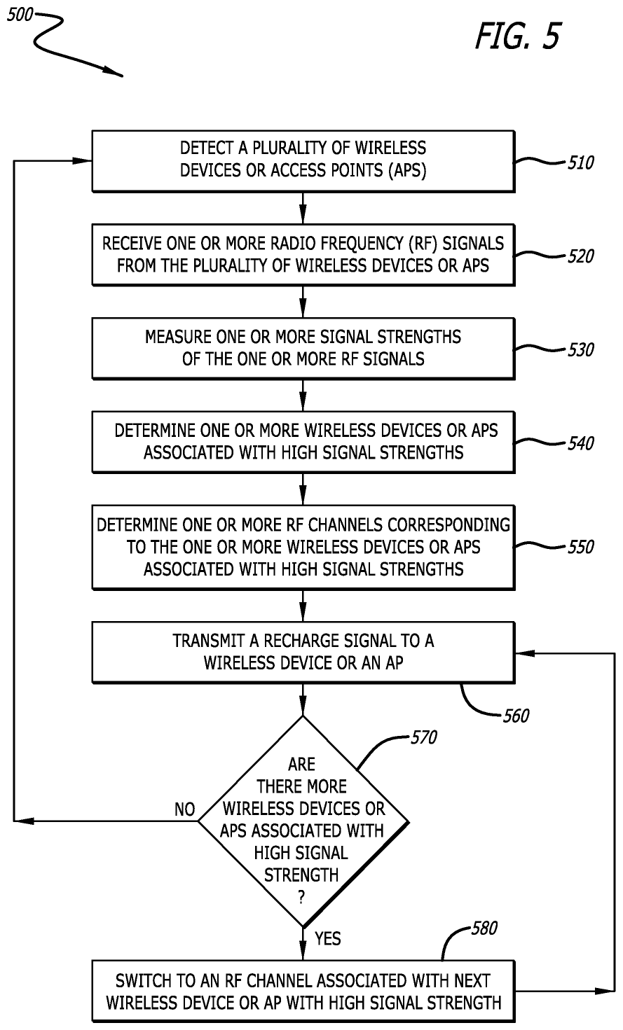

Referring now to FIG. 5, a flowchart depicting a process 500 for selecting the AP or the wireless device, in accordance with various embodiments of the disclosure is shown. In many embodiments, the process 500 can detect a plurality of wireless devices or APs (block 510). In some embodiments, the process 500 can be performed by the ambient power device. In certain embodiments, the process 500 may utilize Wi-Fi scanning, signal strength measurement, Service Set Identifier (SSID) broadcasts, Probe Requests/Responses, beacon frames, location-based services, or network discovery protocols etc. for example, to detect the wireless devices or the APs. In more embodiments, the wireless devices may function as a receiver, an energizer, a proxy, or a buddy device for the ambient power device.

In a number of embodiments, the process 500 can receive one or more RF signals from the wireless devices or APs (block 520). In some embodiments, the RF signals can include the beacon frames transmitted by the APs or the wireless devices, for example. In certain embodiments, the RF signals may include the probe responses transmitted by the APs or the wireless devices in response to the probe requests received from the ambient power devices or any other devices. In more embodiments, the RF signals can be Wi-Fi signals.

In various embodiments, the process 500 may measure one or more signal strengths of the RF signals (block 530). In that, in some embodiments, the process 500 can measure Received Signal Strength Indication (RSSI) values of the RF signals. In certain embodiments, the RSSI of the RF signals can vary based on one or more parameters such as but not limited to distance of the ambient power device from the APs or the wireless devices, interference, obstacles in vicinity of the ambient power devices, density of devices in an area etc. for example.

In additional embodiments, the process 500 can determine the wireless devices or APs associated with high signal strengths (block 540). In some embodiments, the APs and/or wireless devices having highest signal strengths can be the APs and/or wireless devices closest to the ambient power device. In certain embodiments, the process 500 can store a list of the APs or the wireless devices and corresponding RSSI values.

In further embodiments, the process 500 may determine the RF channels corresponding to the one or more wireless devices or APs associated with high signal strengths (block 550). in some embodiments, the process 500 can dynamically select the RF channel utilized by the AP or the wireless device. In certain embodiments, selecting the RF channels utilized by the closest APs or wireless devices can increase the likelihood that the recharge signal will be heard by the APs or the wireless devices in vicinity.

In many more embodiments, the process 500 can transmit the recharge signal or the encoded and/or modulated recharge signal to a wireless device or an AP (block 560). In some embodiments, the recharge signal or the encoded and/or modulated recharge signal may be transmitted on the selected RF channel. In certain embodiments, the process 500 may transmit the recharge signal multiple times. In more embodiments, the process 500 can broadcast the recharge signal.

In many additional embodiments, the process 500 may check if there are more wireless devices or APs associated with high signal strength (block 570). In some embodiments, the process 500 can continuously or periodically monitor the wireless devices or the APs and measure the signal strengths. In certain embodiments, the process 500 may prioritize transmission of the recharge signal to the wireless devices or the APs associated with the highest signal strengths.

In many further embodiments, if at block 570 the process 500 determines that there are no more wireless devices or APs associated with the highest signal strength, the process 500 can continue to detect more or new wireless devices or APs (block 510). In some embodiments, the wireless devices and/or the ambient power devices can move, and hence, distances between the wireless devices and the ambient power devices may change. In that, in certain embodiments, new wireless devices can be dynamically detected by the ambient power device. In more embodiments, the process 500 may reiterate the block 570 to check whether the recharge signal has been transmitted to all possible wireless devices or APs that can be heard by the ambient power device.

In still many embodiments, if at block 570 the process 500 determines that there are more wireless devices or APs associated with the highest signal strength, the process 500 can switch to the RF channel associated with the next wireless device or AP (block 580). In some embodiments, the process 500 may utilize dynamic frequency selection, band steering, or any other protocol-specific techniques to switch to the next RF channel. In certain embodiments, the process 500 can transmit the recharge signal on more than one RF channels.

Although a specific embodiment for the process 500 for selecting the AP or the wireless device associated with the highest signal strength for carrying out the various steps, processes, methods, and operations described herein is discussed with respect to FIG. 5, any of a variety of systems and/or processes may be utilized in accordance with embodiments of the disclosure. For example, the process 500 can ensure that the recharge signal is transmitted to all possible wireless devices and/or APs. The elements depicted in FIG. 5 may also be interchangeable with other elements of FIGS. 1-4 and FIGS. 6-8 as required to realize a particularly desired embodiment.

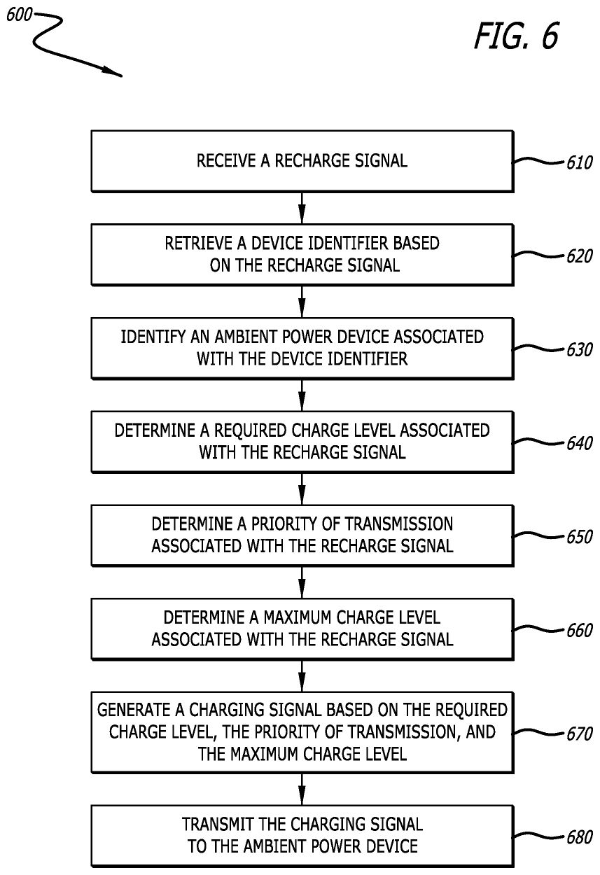

Referring now to FIG. 6, a flowchart depicting a process 600 for charging the ambient power device, in accordance with various embodiments of the disclosure is shown. In many embodiments, the process 600 can receive the recharge signal (block 610). In some embodiments, the process 600 can be implemented by the APs and/or the wireless devices that are in communication with the ambient power devices. In certain embodiments, process 600 may detect the predetermined sequence of bits in the uplink frames. In more embodiments, upon detecting the predetermined sequence of bits, the process 600 can determine that the uplink frames are indicative of the recharge signal.

In a number of embodiments, the process 600 can retrieve the device identifier based on the recharge signal (block 620). In some embodiments, the process 600 may retrieve the device identifier or the encoded device identifier, or the encoded identification bits from the uplink frames. In certain embodiments, examples of the device identifiers include but are not limited to, an address (for e.g. MAC address) of the ambient power device, device type or name of the ambient power device, or serial number associated with the ambient power device etc.

In various embodiments, the process 600 may identify the ambient power device associated with the device identifier (block 630). In some embodiments, each device identifier can be uniquely associated with one ambient power device. In certain embodiments, the process 600 can identify the ambient power devices by utilizing one or more of: network scanning, protocol analysis, physical inspection, and database lookup techniques.

In additional embodiments, the process 600 can determine the required charge level associated with the recharge signal (block 640). In some embodiments, the required charge level can be indicative of a minimum charge level required by the ambient power device for transmission of the uplink data. In certain embodiments, the required charge level may be indicative of the one or more uplink transmission parameters such as but not limited to a number of uplink frames to be transmitted, duration of the uplink frames, or signal strength of the uplink frames etc. for example.

In further embodiments, the process 600 may determine the priority of transmission associated with the recharge signal (block 650). In some embodiments, the process 600 can determine the priority of transmission associated with the recharge signal based on a value of the priority field included in the uplink frames. In certain embodiments, the priority of the transmission of the uplink data signal can be indicative of one or more of: the urgency or importance of the uplink data, the operational state of the ambient power device, the location of the ambient power device, or nature of the uplink data (for e.g. real-time or near-real time), time sensitivity of the uplink data, or volume of the uplink data etc. for example. In more embodiments, the priority of the transmission of the uplink data signal can also be indicative of one or more device characteristics or transmission characteristics of the ambient power device.

In many more embodiments, the process 600 can determine the maximum charge level associated with the recharge signal (block 660). In some embodiments, the maximum charge level can be associated with the energy storage such as but not limited to the capacitor or the battery of the ambient power device. In more embodiments, the maximum charge level can also be indicative of a time required to fully charge the ambient power device.

In many additional embodiments, the process 600 may generate a charging signal based on the required charge level, the priority of transmission, and the maximum charge level (block 670). In some embodiments, the charging signal can comprise the charging frames to be transmitted to the ambient power device. In certain embodiments, the process 600 can, based on the recharge signal, determine a number of charging frames and/or a duration of charging frames required to charge the energy storage of the ambient power device to the required charge level and/or the maximum charge level.

In many further embodiments, the process 600 can transmit the charging signal to the ambient power device (block 680). In some embodiments, the process 600 may perform off-channel charging by transmitting the charging frames on the RF channel different from the RF channel utilized by the ambient power device for transmitting the uplink frames. In certain embodiments, the process 600 can simultaneously receive the uplink frames from the ambient power device.

Although a specific embodiment for the process 600 for charging the ambient power device for carrying out the various steps, processes, methods, and operations described herein is discussed with respect to FIG. 6, any of a variety of systems and/or processes may be utilized in accordance with embodiments of the disclosure. For example, the process 600 can transmit different charging signals to different ambient power devices based on respective charge requirements of the ambient power devices. The elements depicted in FIG. 6 may also be interchangeable with other elements of FIGS. 1-5 and FIGS. 7-8 as required to realize a particularly desired embodiment.

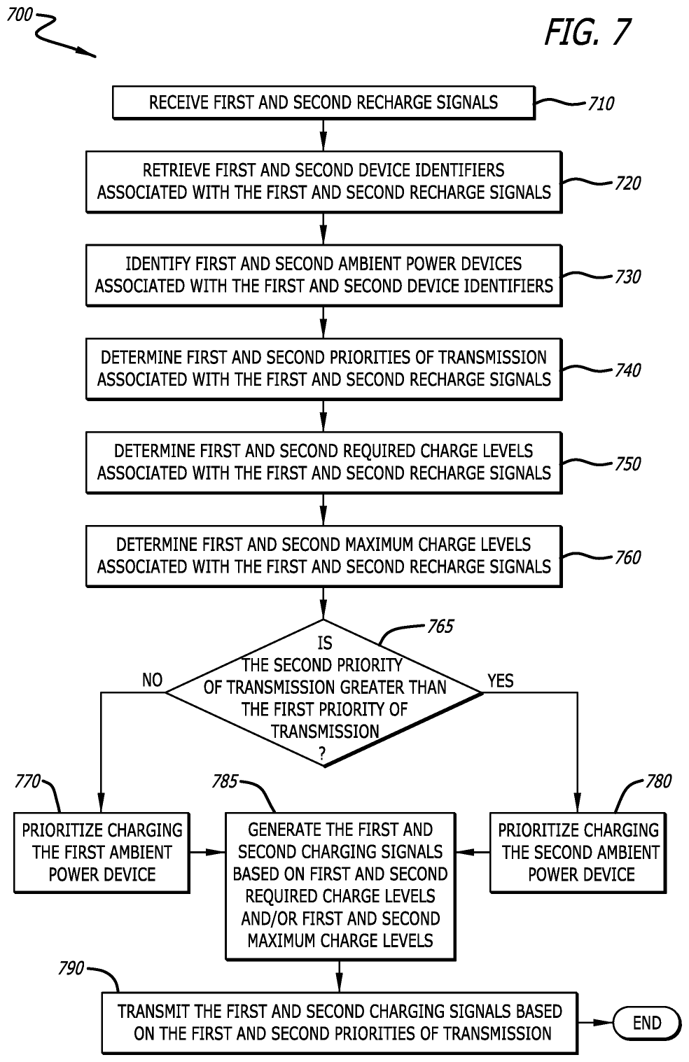

Referring now to FIG. 7, a flowchart depicting a process 700 for prioritizing the charging of the ambient power devices, in accordance with various embodiments of the disclosure is shown. In many embodiments, the process 700 can receive first and second recharge signals (block 710). In some embodiments, the first and second recharge signals may be transmitted by the first and second ambient power devices. In certain embodiments, the first and second ambient power devices can possess different charge requirements, device characteristics, or maximum charge levels, etc. In certain embodiments, the first and second recharge signals may be received on the same RF channel or on different RF channels.

In a number of embodiments, the process 700 may retrieve first and second device identifiers associated with the first and second recharge signals (block 720). In some embodiments, the first and second recharge signals can include first and second sets of encoded device identifiers respectively. In certain embodiments, the process 700 may decode the first and second sets of encoded device identifiers to retrieve the first and second device identifiers respectively. In more embodiments, the first and second device identifiers can uniquely correspond to the first and second ambient power devices respectively.

In various embodiments, the process 700 can identify the first and second ambient power devices associated with the first and second device identifiers (block 730). In some embodiments, the process 700 can utilize one or more of: network scanning, protocol analysis, physical inspection, and database lookup techniques etc. for example, for identifying the first and second ambient power devices. In certain embodiments, the process 700 may associate the first and second recharge signals with the first and second ambient power devices.

In additional embodiments, the process 700 may determine first and second priorities of transmission associated with the first and second recharge signals (block 740). In some embodiments, the first and second priorities of the transmission may be indicated by the priority fields in the uplink frames utilized for transmitting the first and second recharge signals. In certain embodiments, the priority fields can be one or more bits in the uplink frames. In more embodiments, the values of the priority fields can vary based on the type of the uplink data scheduled to be transmitted by the first and second ambient power devices.

In further embodiments, the process 700 can determine first and second required charge levels associated with the first and second recharge signals (block 750). In some embodiments, the first and second required charge levels can be indicative of the minimum charge required by the energy storages of the first and second ambient power devices to transmit the uplink data. In certain embodiments, the first and second required charge levels can be different for every recharge signal received from the first and second ambient power devices.

In many more embodiments, the process 700 can determine first and second maximum charge levels associated with the first and second recharge signals (block 760). In some embodiments, the first and second maximum charge levels may be indicative of the charge levels required to fully charge the energy storages of the first and second ambient power devices. In certain embodiments, the first and second maximum charge levels can be indicative of the time required to fully charge the energy storages of the first and second ambient power devices.

In many additional embodiments, the process 700 may check whether the second priority of transmission is greater than the first priority of transmission (block 765). In some embodiments, the process 700 can compare the first and second values of the priority fields in the uplink frames. In some embodiments, the ambient power devices associated with critical functions or network functions may have higher priority.

If at block 765, the process 700 determines that the second priority of transmission is not greater than the first priority of transmission, in many further embodiments, the process 700 can prioritize charging the first ambient power device (block 770). In some embodiments, the process 700 can first transmit a first charging signal to the first ambient power device. In more embodiments, the process 700 may assign a greater number of charging frames to the first ambient power device. In certain embodiments, the process 700 can assign the charging frames of longer duration to the first ambient power device.

If at block 765, the process 700 determines that the second priority of transmission is greater than the first priority of transmission, in still many embodiments, the process 700 can prioritize charging the second ambient power device (block 780). In some embodiments, the process 700 can first transmit a second charging signal to the second ambient power device. In more embodiments, the process 700 may assign a greater number of charging frames to the second ambient power device. In certain embodiments, the process 700 can assign the charging frames of longer duration to the second ambient power device.

In still further embodiments, the process 700 can generate the first and second charging signals based on first and second required charge levels and/or first and second maximum charge levels (block 785). In some embodiments, the process 700 may determine the number of charging frames or the duration of charging frames required to charge the energy storages of the first and second ambient power devices to the first and second required charge levels or the first and second maximum charge levels. In certain embodiments, the process 700 can determine the RF channels to transmit the first and second charging signals.

In numerous embodiments, the process 700 may transmit the first and second charging signals based on the first and second priorities of transmission (block 790). In some embodiments, the process 700 can transmit the charging frames to the first and second ambient power devices. In certain embodiments, the first and second ambient power devices may utilize the charging frames to recharge the respective energy storages.

Although a specific embodiment for the process 700 for prioritizing the charging of the ambient power devices for carrying out the various steps, processes, methods, and operations described herein is discussed with respect to FIG. 7, any of a variety of systems and/or processes may be utilized in accordance with embodiments of the disclosure. For example, the process 700 can charge the first and second ambient power devices either simultaneously or sequentially. The elements depicted in FIG. 7 may also be interchangeable with other elements of FIGS. 1-6 and FIG. 8 as required to realize a particularly desired embodiment.

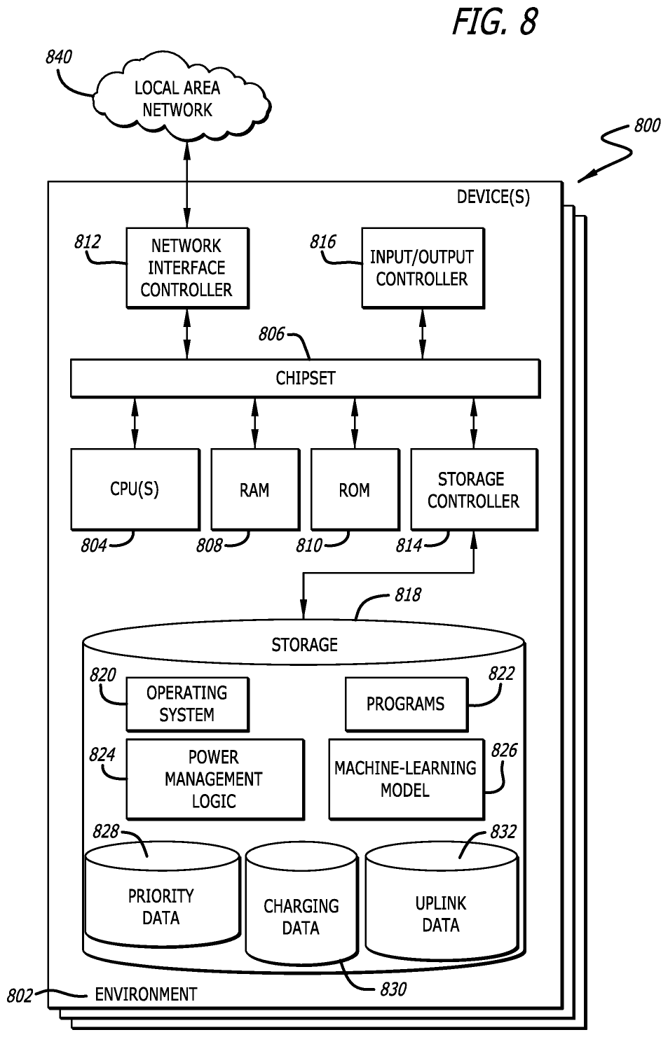

Referring to FIG. 8, a conceptual block diagram of a device 800 suitable for configuration with a power management logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, priority data 828, charging data 830, and uplink data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The priority data 828 can store the priorities of transmissions associated with the ambient power devices. The priority data 828 can also store the priorities of the uplink data received from the ambient power devices. The charging data 830 may store the required charging levels or the maximum charging levels associated with the ambient power devices. The uplink data 832 can store the uplink data received by way of the uplink frames or the uplink signal. The uplink data can be indicative of the values of the physical parameters measured by the ambient power devices.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-crasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a power management logic 824. The power management logic 824 can be configured to perform one or more of the various steps, processes, operations, and/or other methods that are described above. Often, the power management logic 824 can be a set of instructions stored within a non-volatile memory that, when executed by the processor(s)/controller(s) 804 can carry out these steps, etc. In some embodiments, the power management logic 824 may be a client application that resides on a network-connected device, such as, but not limited to, a server, switch, personal or mobile computing device in a single or distributed arrangement. The power management logic 824 can recharge the ambient power devices.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the priority data 828, the charging data 830, and the uplink data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for the device 800 suitable for configuration with the power management logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a power management logic, configured to:
monitor a current charge level of an energy storage;
compare the current charge level with a threshold charge level; and
generate, when the current charge level falls below the threshold charge level, a recharge signal indicative of a request to recharge the energy storage.

2. The device of claim 1, wherein the recharge signal comprises one or more encoded identification bits corresponding to a device identifier.

3. The device of claim 2, wherein the power management logic is further configured to:
determine a required charge level for transmitting an uplink data signal; and
determine a priority of transmission of the uplink data signal.

4. The device of claim 3, wherein the recharge signal is further indicative of at least one of: the required charge level or the priority of transmission.

5. The device of claim 4, wherein the recharge signal is further indicative of a maximum charge level associated with the energy storage.

6. The device of claim 5, wherein the power management logic is further configured to modulate the recharge signal to generate a modulated recharge signal.

7. The device of claim 6, wherein the power management logic is further configured to:
detect a plurality of wireless devices;
receive one or more Radio Frequency (RF) signals from the plurality of wireless devices;
measure one or more signal strengths of the one or more RF signals; and
determine one or more wireless devices associated with a highest signal strength of the one or more signal strengths.

8. The device of claim 7, wherein the power management logic is further configured to determine one or more RF channels associated with the one or more wireless devices.

9. The device of claim 8, wherein the power management logic is further configured to transmit at least one of: the recharge signal or the modulated recharge signal to the one or more wireless devices on the one or more RF channels.

10. The device of claim 9, wherein the power management logic is further configured to:
receive at least one charging signal from the one or more wireless devices in response to the recharge signal; and
recharge the energy storage based on the at least one charging signal.

11. The device of claim 10, wherein the energy storage is a battery or a capacitor.

12. The device of claim 11, wherein the power management logic is further configured to dynamically modify the threshold charge level.

13. A device, comprising:
a processor;
a memory communicatively coupled to the processor; and
a power management logic, configured to:
receive a first recharge signal;
retrieve a first device identifier based on the first recharge signal;
identify a first ambient power device associated with the first device identifier; and
transmit a first charging signal to the first ambient power device.

14. The device of claim 13, wherein the power management logic is further configured to determine a first required charge level associated with the first recharge signal.

15. The device of claim 14, wherein the power management logic is further configured to determine a first priority of transmission associated with the first recharge signal.

16. The device of claim 15, wherein the power management logic is further configured to generate the first charging signal based on the first required charge level and the first priority of transmission.

17. The device of claim 16, wherein the power management logic is further configured to:
receive a second recharge signal from a second ambient power device;
determine a second priority of transmission associated with the second recharge signal; and
compare the first priority of transmission and the second priority of transmission.

18. The device of claim 17, wherein the power management logic is further configured to transmit a second charging signal to the second ambient power device if the second priority of transmission is greater than the first priority of transmission.

19. A method, comprising:
monitoring a current charge level of an energy storage of an ambient power device;
generating one or more encoded identification bits corresponding to a device identifier associated with the ambient power device;
comparing the current charge level with a threshold charge level; and
generating, when the current charge level falls below the threshold charge level, a recharge signal comprising the one or more encoded identification bits.

20. The method of claim 19, wherein generating the recharge signal comprises:
determining a required charge level for transmitting an uplink data signal;
determining a priority of transmission of the uplink data signal; and
generating the recharge signal based on the required charge level and the priority of transmission,
wherein the recharge signal is indicative of a request to recharge the energy storage.
